(19) United States
(12) Patent Application Publication
(10) Pub. No.: US 2012/0036774 A1
(43) Pub. Date: Feb. 16, 2012

(54) PLANTED WALL OR PLANTED FACADE

(75) Inventor: Pascal Peleszezak, Tarare (FR)

(73) Assignee: CANEVAFLOR, Tarare (FR)

(21) Appl. No.: 13/202,594

(22) PCT Filed: Feb. 18, 2010
(86) PCT No.: PCT/FR2010/050273

§ 371 Date: Nov. 2, 2011

(30) Foreign Application Priority Data
Feb. 20, 2009 (FR) 0951102

(51) Int. Cl. A01G 9/02

(52) U.S. Cl. 47/66.6

(57) ABSTRACT

The wall or the frontage includes areas receiving plants and photovoltaic panels where the panels, arranged alternately with respect to the areas covered with plants, are cooled by an airflow circulating in contact with the plants, which allows operation of the photovoltaic panels under optimum conditions.

### TECHNICAL FIELD

The present invention relates to a vegetated wall or a vegetated frontage, which forms a structure which may be for example set up on the border of a roadway or a building gable, in an urban or other environment.

### BACKGROUND

A structure for a vegetated wall is for example known from French patent FR 2872381 or its equivalent the European patent EP 1771062, in the name of the Applicant.

Vegetative walls presently have an essentially decorative function, or at least a passive role, in particular: urban facelifts, concealing ugly stone or concrete walls, anti-noise screens. With the plants which they include, these vegetated walls also have an anti-pollutant role towards the ambient atmosphere, notably in an urban medium or along traffic routes.

### BRIEF SUMMARY

The invention provides an enhanced vegetated wall or vegetated frontage which may play an <<active>> role in addition to its usual functions, in particular from the energy point of view.

For this purpose, the invention provides a vegetated wall or vegetated frontage, including areas receiving plants or suitable for receiving plants, this wall or this frontage being essentially, characterized in that the fact that it also includes photovoltaic panels, capable of being cooled by air circulating in contact with the plants.

Thus, the idea at the basis of the present invention takes advantage of the cooling of the air, resulting from the evapo-transpiration phenomenon of leaves of the plants of the vegetated wall, for cooling photovoltaic panels set up on the same wall, in order to optimize the yield of these photovoltaic panels and their production of electricity.

Indeed it is known that photovoltaic panels operate in an optimum way at a moderate temperature, while their exposure to solar radiation brings them up to a higher temperature, making cooling desirable of these panels. By placing photovoltaic panels on a vegetated wall, a <<natural>> cooling means not consuming any exterior energy is made available. More specifically, evapotranspiration of the leaves generates natural ventilation and cooling of the photovoltaic panels by convection, without providing any external energy and this under ideal conditions since:
in winter, the plants do not have any leaves but the ambient temperature being low, there is no need for cooling the photovoltaic panels;
in summer, the plants have leaves by which the cooling effect is obtained.

In particular, under summer conditions, the photovoltaic panels may thus be maintained at the ambient temperature for example comprised between 25 and 30° C., for optimum operation, while their usual temperature (under solar radiation) would be of the order of 50 to 55° C.

Taking into account the usual thickness of the leaves, and for guiding the cooled air flow between the wall or the frontage structure and the photovoltaic panels, these panels are advantageously placed so as to protrude, i.e. in front of the areas receiving the plants or suitable for receiving the plants.

An alternating arrangement of the plants and of the photovoltaic panels, over the whole extent of the vegetated wall or of the vegetative frontage seems to be particularly advantageous. For this purpose the areas receiving plants or suitable for receiving plants on the one hand and the photovoltaic panels on the other hand may be arranged in an alternating way, notably
by forming horizontal bands, or
by forming vertical bands, or further
by forming a checkerboard.

Advantageously, the areas receiving the plants or suitable for receiving plants, on the one hand, and the photovoltaic panels, on the other hand, represent each other respectively about 50% of the total extension of the vegetated wall or of the vegetated frontage.

It will be noted that by the advanced position of the photovoltaic panels, and by their alternating arrangement with the areas covered with plants, these panels cast over the plants a shadow which contributes to their cooling, therefore, to the cooling of the air which circulates in contact with the plants and will itself cool the photovoltaic panels.

Taking into account the extent of the photovoltaic panels, thermal and/or phonic protective elements are preferably provided at the rear of the photovoltaic panels. These protective elements ensure the continuity of the thermal and/or phonic insulation properties of the vegetated wall or of the vegetated frontage, in portions located between the areas covered with plants. Thus, the addition of the photovoltaic panels does not alter the thermal and phonic insulation properties of the wall or of the frontage according to the invention.

These photovoltaic panels may be set up vertically on the vegetated wall or the vegetated frontage, or be set up in a tilted position which is advantages from the double point of view of capturing solar radiation with these panels and forming the shadow cast by these panels on the areas covered with plants. An assembly of said photovoltaic panels with a possibility of mechanical orientation of these panels may also be contemplated.

The vegetated wall or the vegetated frontage may operate with entirely natural ventilation, all the electric energy provided by the photovoltaic panels may, in this case, be used outside the wall or the frontage.

However, in an alternative of this vegetated wall or this vegetated frontage, the latter comprises motorized means for forced circulation of air in contact with the plants and the photovoltaic panels, these means being supplied with electric energy from the actual photovoltaic panels. Forced circulation of the air is thereby created, which of course requires energy, but which remains highly profitable from the energy balance point of view, if it is considered that:
the electric energy used for driving the means for forced circulation of the air is produced by the actual photovoltaic panels, and not provided from an external source;
the improved cooling of the photovoltaic panels, which is the result of the forced circulation of the air, induces an improvement in the yield of these panels, which greatly compensates for the amount of energy taken for obtaining this forced circulation.

Thus, in every case, the vegetated wall or the vegetated frontage, equipped with photovoltaic panels may provide energy to the outside world. The larger the wall or the frontage, the larger will proportionally be the surface area of the photovoltaic panels, the provided electric power may therefore be high.

If it is desired, a portion of this electric power may also be used, on the vegetated wall or the vegetated frontage, for example, for powering an illumination system, which enhances this wall or this frontage. Likewise, photovoltaic panels may economically supply energy to a self-contained system fitting out the vegetated wall or the vegetated frontage, others, such as a system for irrigation or mist propagation on areas covered with plants, or further a cleaning system, notably for cleaning the photovoltaic panels.

### BRIEF DESCRIPTION OF THE DRAWINGS

The invention will be better understood by means of the following description, referring to the appended schematic drawing illustrating as examples. A few embodiments of this vegetated wall or this vegetated frontage.

FIG. 1 is a front view of a vegetative wall with photovoltaic panels, according to the invention;

FIG. 2 is a planar view from above the vegetated wall of FIG. 1;

FIG. 3 is a plain R view from above, similar to FIG. 2, relating to a first alternative;

FIG. 4 is a front view of a vegetated wall according to another alternative;

FIG. 5 is a plain R view from above of this other alternative.

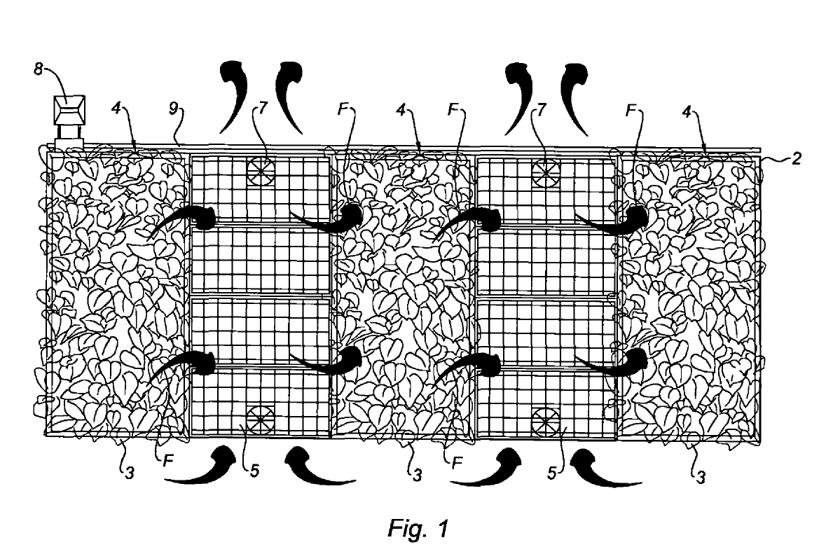

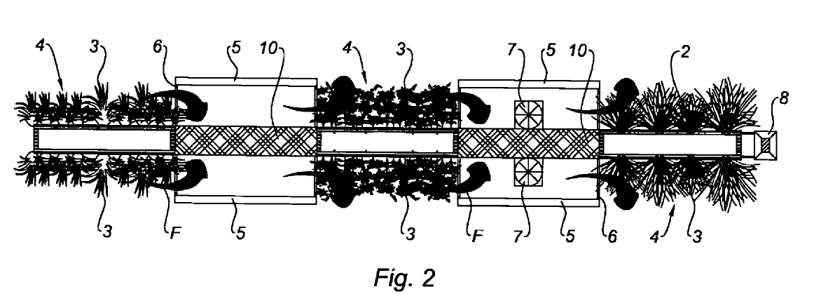

FIGS. 1 and 2 show a vegetated wall, which includes a central framework 2, extending in a vertical plane, on either side of which plants 3 grow.

### DETAILED DESCRIPTION

More particularly, the areas 4, which received here the plants 3 extend along the vertical bands, separated from one another by intervals, the width of which is substantially equal to those of these areas 4.

Between the areas 4 or bands covered with plants 3, extend other vertical bands in which are arranged, on both faces of the wall, photovoltaic panels 5 are maintained on the central framework 2, by supports or brackets 6.

These supports or brackets 6 position the photovoltaic panels 5 in front of the central framework 2 and of the areas 4, the prominence of the panels 5 substantially corresponding to the thickness of the leaves of the plants 3 planted in the areas 4—see FIG. 2.

The photovoltaic panels 5 are illustrated as vertical, for the sake of simplicity, but they may also advantageously be tilted either constantly or with a possibility of mechanical orientation.

During operation, an air flow symbolized by arrows F substantially circulates in the vertical plane of the plant wall, the air being cooled in contact with the leaves of the plants 3, as a result of the evapo-transpiration effect, and the this air will then lick and cool the photovoltaic panels 5. Thus, the photovoltaic panels 5 operate under optimum conditions, as regards their energy efficiency.

The electric energy produced by the photovoltaic panels 5 may be used at a distance from the plant wall, but it may also power some useful equipment of this wall, as described hereafter.

Firstly, electric motor fan units 7 may be mounted on the framework 2 of the vegetated wall, in order to accelerate the airflow by generating some forced circulation. The electric motors of the motor fan units 7 are powered by the photovoltaic panels 5, while only consuming a limited fraction of the electric power generated by these panels 5.

The framework 2 may also bear, for example in its high portion, an illumination system symbolized by a lamp 8, for illumination by night and for highlighting the vegetated wall. This illumination system is also supplied with electric energy from the actual photovoltaic panels 5.

A mist propagation system, symbolized by a mist propagation pipe 9, may be borne by the high portion of the framework 2, in order to produce additional cooling, and optionally cleaning of the photovoltaic panels 5 by nebulization of water. The pump circulating this water, as well as the members for controlling and regulating the mist propagation system 9 may also here be supplied with electric energy from photovoltaic panels 5.

In the case of mechanically orientable photovoltaic panels 5, the electric energy produced by these panels may be used for powering the mechanism for orienting these actual panels.

Further, for the sake of safety and durability, and for being able to electrically power at any moment the equipment of the vegetated wall, either a storage of the electric energy produced by the photovoltaic panels 5, or an external electric power supply through a standard electricity distribution network are may be contemplated.

Preferably, thermal and/or phonic protective elements 10 in the form of plates of suitable materials and thickness are placed at the rear of the various photovoltaic panels 5. These elements 10 ensure continuity of the thermal and/or phonic insulation properties of the vegetated wall, in the bands located between the areas 4 covered with plants 3.

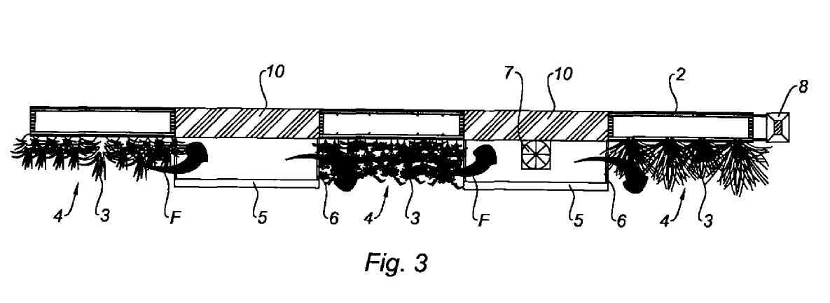

FIG. 3, in which the corresponding portions are designated with the same numerical references, illustrates an alternative vegetated wall or vegetated frontage according to the invention, in which the plants 3 and the photovoltaic panels 5 are only provided on a single face of the framework 2, thermal and/or phonic protective elements 10 are being here again arranged between the areas 4 covered with plants 3, at the rear of the photovoltaic panels 5.

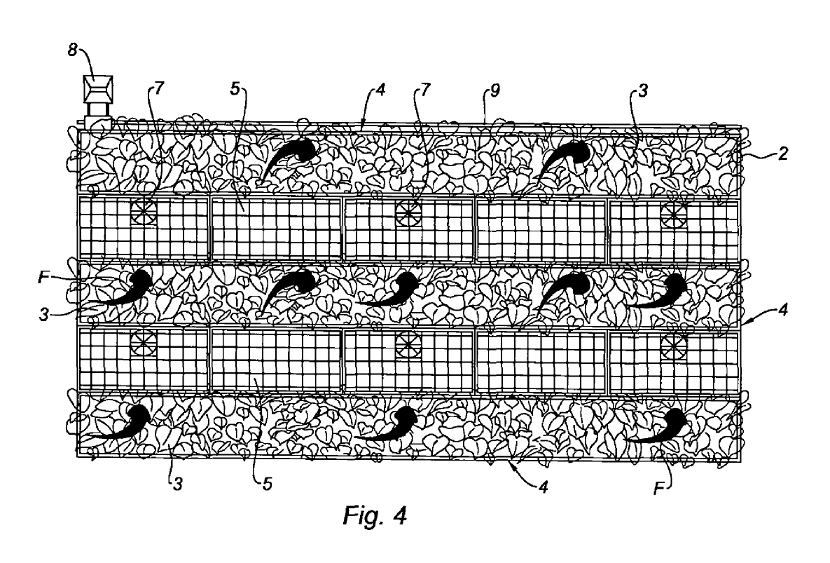

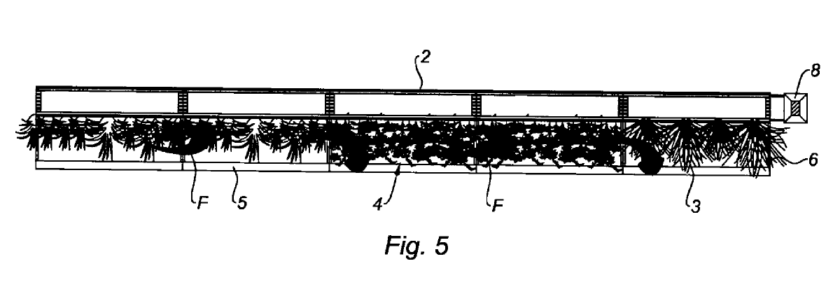

Finally, FIGS. 4 and 5 illustrates another alternative, in which the areas 4 covered with plants 3 and the photovoltaic panels 5 are arranged not along the vertical bands but along horizontal bands always with alternation of these bands.

There would not be any departure from the scope of the invention as defined in the appended claims:
if the areas covered with plants and the photovoltaic panels are arranged as a checkerboard i.e. with both vertical and horizontal alternation;
if all the annex equipment is powered by means of the photovoltaic panels of the vegetated wall or the vegetated frontage.

1. A vegetated wall or vegetated frontage, including areas receiving plants or suitable for receiving plants, characterized in wherein the wall or the frontage includes photovoltaic panels, capable of being cooled by fair circulating in contact with the plants.

2. The vegetated wall or the vegetated frontage according to claim 1, wherein the photovoltaic panels are placed so as to protrude, in front of the areas receiving the plants or suitable for receiving the plants.

3. The vegetated wall or the vegetated frontage according to claim 1 wherein the areas receiving the plants or suitable for receiving the plants and the photovoltaic are arranged alternately, while forming horizontal or vertical bands.

4. The vegetated wall or the vegetated frontage according to claim 1 wherein the areas receiving the plants or suitable for receiving the plants and the photovoltaic panels are arranged alternately, while forming a checkerboard.

5. The vegetated wall or the vegetated frontage according to claim 1, wherein the areas receiving the plants or suitable for receiving the plants and the photovoltaic panels represent each other respectively about 50% of a total extension of the vegetated wall or of the vegetated frontage.

6. The vegetated wall or the vegetated frontage according to claim 1, wherein thermal and/or phonic protective elements are provided at a rear of the photovoltaic panels.

7. The vegetated wall or the vegetated frontage, according to claim 1, further comprising motorised means for forced circulation of the air in contact with the plants and photovoltaic panels, these means being supplied with electric energy from the actual photovoltaic panels.

8. The vegetated wall or the vegetated frontage according to claim 1, wherein electric energy produced by the photovoltaic panels of the wall or of the frontage is used for powering an illumination system of this wall or of this frontage, and/or an irrigation or mist propagation system for the areas covered with plants, and/or a cleaning system, notably a washing system for the photovoltaic panels.
